(19) United States
(12) Patent Application Publication
(10) Pub. No.: US 2014/0159853 A1
(43) Pub. Date: Jun. 12, 2014

(54) MAGNETIC PASSIVE COMPONENT AND METHOD FOR MANUFACTURING THE SAME

(71) Applicant: Delta Electronics (Chen Zhou) Co., Ltd, Chen Zhou City (CN)

(72) Inventors: Chao Wei YANG, Chen Zhou City (CN); Wangjun HE, Chen Zhou City (CN); Xuefeng CHEN, Chen Zhou City (CN); Chang HSU, Chen Zhou City (CN); Chin Chang PAN, Chen Zhou City (CN); Ming En HSIEH, Taoyuan Hsien (TW)

(73) Assignee: Delta Electronics (Chen Zhou) Co., Ltd, Chen Zhou City (CN)

(21) Appl. No.: 14/099,680

(22) Filed: Dec. 6, 2013

(30) Foreign Application Priority Data
Dec. 7, 2012 (CN) 201210524628.2

(51) Int. Cl. H01F 27/24; H01F 41/02

(52) U.S. Cl. CPC H01F 27/24; H01F 41/0206
USPC 336/221; 29/596

(57) ABSTRACT

A magnetic passive component and a method for manufacturing the same are provided. The magnetic passive component comprises a magnetic core, a metal-wire-layer winding around the surface of the magnetic core, and an insulating layer provided between the magnetic core and the metal-wire-layer. The material of the insulating layer is a kind of insulating material containing additive of metal ions. To form the metal-wire layer, a trace of metal-wire layer should be made first in the surface of the insulating layer by laser activation and then adopt electroplating process to form the metal-wire layer so as to finally form a metal winding wire on a surface of the magnetic core. The magnetic passive component and the method for manufacturing the same disclose here can realize a simple process, a low manufacturing cost, an automatic manufacturing and a stable and reliable quality.

### CROSS-REFERENCE TO RELATED APPLICATIONS

This non-provisional application claims priority under 35 U.S.C. §119(a) on Patent Application No. 201210524628.2 filed in P. R. China on Dec. 7, 2012, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the present invention described herein. All references listed, cited and/or discussed in this specification are incorporated herein by reference in their entireties and to the same extent as if each reference was individually incorporated by reference.

### FIELD OF THE INVENTION

The present invention relates to a magnetic passive component and a method for manufacturing said magnetic passive component, and particularly to a magnetic passive component, which can be automatically manufactured by a simple process, and a method for manufacturing said magnetic passive component.

### BACKGROUND OF THE INVENTION

A magnetic passive component in the prior art is generally made by winding a flat enameled wire into a certain shape and then assembling it with a magnetic-material-made core having a certain shape to form one or more electrical loops. Alternatively, as shown in FIG. 1 showing a structural schematic diagram of a magnetic passive component in the prior art, a magnetic passive component in the prior art can be made by winding a conducting line 10 (which can be a single wire or twisted at least two wires) directly around a magnetic material 20 to form one or more electrical loops. Such magnetic passive component in the prior art has defects that it requires manual winding with high human resource cost and low efficiency. U.S. patent application No. US2011/0108317 entitled “PACKAGED STRUCTURE HAVING MAGNETIC COMPONENT AND METHOD THEREOF” discloses a magnetic passive component. The process of manufacturing such magnetic passive component includes, drilling holes in PCB to form winding through holes; depositing cooper and routing wires, so as to form one or more electrical loops around a magnetic-material-made core. Said method for manufacturing the magnetic passive components has some advantage for the inductor with low inductance but has some limitation for the inductor with large inductance and increase the manufacture cost thereof.

### SUMMARY OF THE INVENTION

An objective of the invention is to provide a magnetic passive component, which can be manufactured in a way of high automatization and low cost, and may have a large inductance. Another objective of the invention is to provide a method for manufacturing said magnetic passive component.

In order to realized the above-mentioned objectives, a magnetic passive component is provided according to an aspect of the invention, which comprises a magnetic core, an insulating layer covering the magnetic core, and a metal-wire-layer deposited on a surface of the insulating layer, wherein the metal-wire-layer has a helical shape and surrounds the surface of the insulating layer.

The metal lines layer of the magnetic passive component forms one or more electrical loops.

The magnetic core of the magnetic passive component may have a structure of a closed geometric shape.

The insulating layer of the magnetic passive component can be made from an insulating material containing additive of metal ions.

In order to realize the above-mentioned objectives, a method for manufacturing a magnetic passive component is provided according to another aspect of the invention. Said method comprises: providing a magnetic core; forming an insulating layer on the magnetic core, the insulating layer being made from an insulating material containing metal ions; forming a trace of metal-wire layer having a helical shape in a surface of the insulating layer; depositing a metal-wire-layer on a surface of the guiding path for the metal ions to form a metal winding wire on a surface of the magnetic core.

In said method for manufacturing the magnetic passive component, the guiding path is formed by laser activated the surface of the insulating layer.

In said method for manufacturing the magnetic passive component, the metal-wire-layer is formed by depositing the metal ions on the surface of the guiding path by electroplating.

In said method for manufacturing the magnetic passive component, the insulating layer is molded by casting on the surface of the magnetic core.

In said method for manufacturing the magnetic passive component, the magnetic core has a structure of a closed geometric shape.

The advantages of the invention are as follows. As compared with a traditional manually winding process, the method according to the invention is more suitable for automatic manufacturing. According to the invention, the way to inform the winding on the magnetic core can eliminate the drilling step and complicate winding step in the prior art process, so that the manufacturing cost is reduced, which is more significant in case of the magnetic passive component having a relative large inductance.

### BRIEF DESCRIPTION OF THE DRAWINGS

Reference will now be made in detail to embodiments of the present invention, examples of which are illustrated in the accompanying drawings and should not be used to limit the invention, wherein:

FIG. 1 is a structural schematic diagram of a magnetic passive component in prior art;

FIG. 2A is a structural schematic diagram of a magnetic passive component according to an embodiment of the invention;

FIG. 2B is a cross sectional view of FIG. 2A;

FIG. 3A is a structural schematic diagram of a magnetic passive component according to another embodiment of the invention;

FIG. 3B is a cross sectional view of FIG. 3A;

FIG. 4A is a structural schematic diagram of a magnetic passive component according to yet another embodiment of the invention;

FIG. 4B is a structural schematic diagram of a magnetic core of the magnetic passive component shown in FIG. 4A;

FIG. 5 is a flow chart of the process manufacturing the magnetic passive component according to the invention.

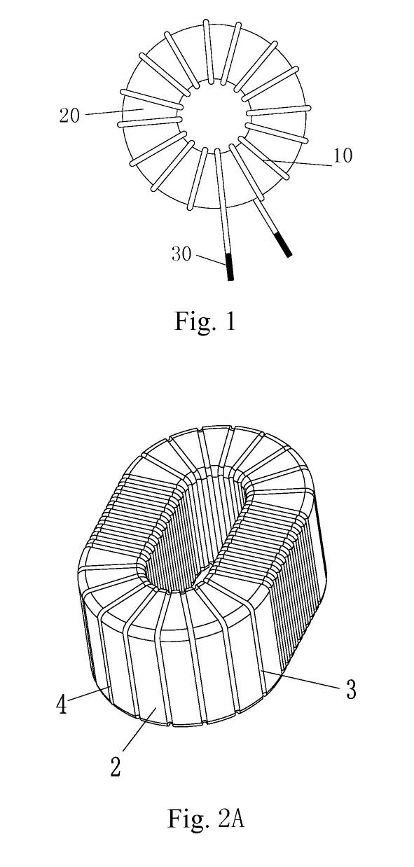

### DETAILED DESCRIPTION OF THE PREFERRED EMBODIMENT

The invention will now be described in details through following illustrative embodiments in combination with the drawings. However, it should be understood that an element, a structure or a feature in an embodiment can be beneficially incorporated into other embodiments without further recitation.

It should also be understood that “comprises/comprising” when used in the specification is taken to specify the presence of stated features, integers, steps or components but does not preclude the presence or addition of one or more other features, integers, steps or components or groups thereof.

The superiority of the invention would be more obvious when the configuration of the magnetic passive component and method of manufacturing the same disclosed herein is applied to magnetic passive component with large inductance. The magnetic passive components have wide range of applications and can be applied to not only PCBs but also high frequency signal transmission or low-frequency power supplies, as inductors or voltage transformers.

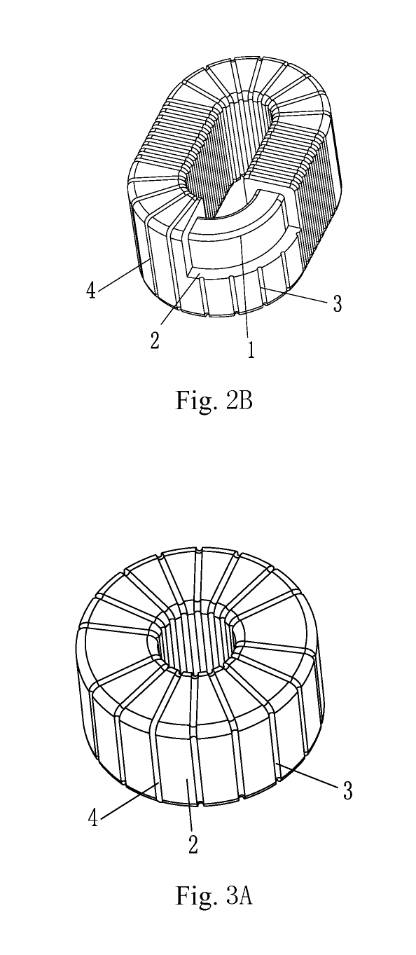

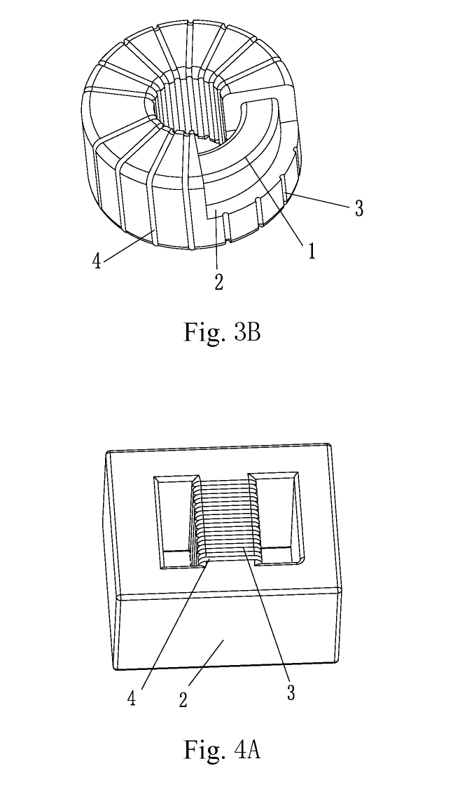

FIG. 2A is a structural schematic diagram of a magnetic passive component according to an embodiment of the present invention. FIG. 2B is a cross sectional view of FIG. 2A. In the embodiment shown in FIG. 2A-2B, a magnetic passive component of the invention comprises a magnetic core 1, an insulating layer 2 covering the magnetic core 1, and a metal-wire-layer 4 deposited on a surface of the insulating layer 2 in such a way that the metal-wire-layer 4 surrounds the surface of the insulating layer 2 and has a helical shape. FIG. 3A is a structural schematic diagram of a magnetic passive component according to another embodiment of the invention. FIG. 3B is a cross sectional view of FIG. 3A. In the embodiment shown in FIG. 3A-3B, a magnetic passive component comprises a magnetic core 1, a metal-wire-layer 4 surrounding and wrapping around an outer surface of the magnetic core 1, and an insulating layer 2 provided between the magnetic core 1 and the metal-wire-layer 4.

In said two embodiments, both of the insulating layers 2 are insulating material layers containing additive of metal ions, and closely cover the outer surface of the magnetic core 1. One or more metal-wire-layers 4 can be provided on the outer surface of the insulating layer 2 to form one or more electrical loops. The metal-wire-layer is functionally equivalent to a common metal winding wire on the magnetic core. However, since the producing process of the metal-wire-layer is different from that of the common metal winding wire wound around the magnetic core, the metal-wire-layer is thinner in appearance than the traditional metal winding wire made of the enameled wire wound around the magnetic core. In practice, a trace of metal-wire layer 3 is formed in the insulating layer 2 at a position corresponding to the metal-wire-layer 4. As shown in FIG. 2B or FIG. 3B, the trace of metal-wire layer 3 is substantively covered by the metal-wire-layers 4. The metal-wire layers 4 can deposit on the insulating layer 2 follow the trace of metal-wire layer 3.

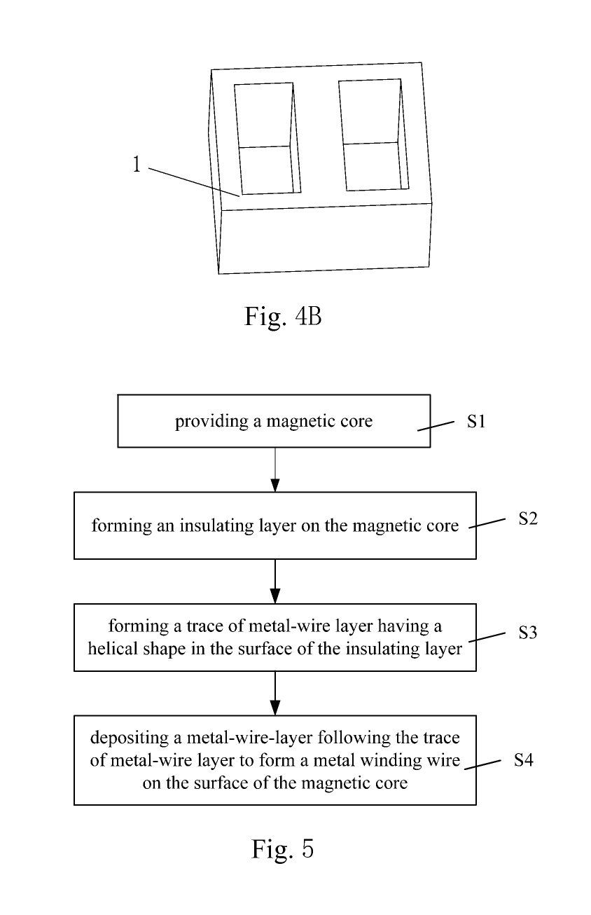

The magnetic core of the magnetic passive component can be shaped into a ring-shape as shown in FIG. 2 or FIG. 3, or alternatively into any other closed geometric shape. FIG. 4 illustrates another structure of the magnetic passive component. As shown in FIGS. 4A and 4B, the magnetic core of the magnetic passive component 1 has a structure with a “ [symbol] ”-character shape. As shown in FIG. 4A, the metal-wire-layers 4 are positioned surround a middle transversal portion of the “ [symbol] ”-character shape. The “ [symbol] ”-character shape is also considered as a closed geometric shape.

According to another aspect of the invention, a method for manufacturing the magnetic passive component is described. Referring to FIG. 5, which illustrates a flow chart of the process manufacturing the magnetic passive component of the embodiment, said method of the invention comprises: providing the magnetic core 1 (step S1); forming the insulating layer 2 on the magnetic core 1 (step S2); forming the trace of metal-wire layer 3 having a helical shape in the surface of the insulating layer 2 (step S3); and depositing the metal-wire-layers 4 following the trace of metal-wire layer 3 to finally form the metal winding wire on the surface of the magnetic core 1 (step S4).

In the step S2, the insulating layer 2 can be formed on the surface of the magnetic core 1 by casting with a mold. In particularly, for example, a cavity mold is provided, which has a cavity. A supporting post is contained in the cavity for supporting the magnetic core deposed in the cavity. Therefore, in practice, the cavity mold is selected to match the shape of the magnetic core of the magnetic passive component to be manufactured. When forming the insulating layer 2 by using the cavity mold as described above, the insulating material is melted into a molten state, and then poured into the cavity to harden into shape, It should understood that the method for forming the insulating layer 2 on the surface of the magnetic core is not limited to the method as illustrated herein. The insulating layer 2 can be made from insulating material containing additive of metal ions.

In the step S3, one or more trace of metal-wire layer 3 can be formed by laser selectively activating the surface of the insulating layer 2. In particularly, for example, a carrier for the magnetic core and a laser instrument for emitting a laser can be provided. The magnetic core is deposed on the carrier, and a predetermined position on the insulating layer covering the surface of the magnetic core is laser directly activated by the laser instrument. The predetermined position is the position where the trace of metal-wire layer 3 to be formed in the surface of the insulating layer. The specific method for forming the trace of metal-wire layer having a helical shape can be slightly different by using different manufacturing devices. For example, a trace of metal-wire layer 3 can be formed into the helical shape by laser activating the material at predetermined position on the surface of the insulating layer 2 through rotation and/or movement of the carrier, or rotation and/or movement of the laser instrument, or relative rotation and/or movement between the carrier and the laser instrument. The trace of metal-wire layer 3 as required can be also designed and formed by other specific method of laser selectively activating the surface of the insulating layer surface covering the magnetic core, which is not limited to the examples as illustrated here above.

In the step S4, the metal-wire-layer 4 can be formed by an electrodeposition process. An amount of the metal ions contained in an electroplating solution is for example listed in the following table:

| Kind | Concentration of metal ion in the |
|---|---|
| of metal ion | electroplating solution |
| Cu | 2.0~6.0 g/l |
| Ni | 2.0~6.0 g/l |
| Pd | 1.5~3.5 g/l |
| Au | 1.0~3.0 g/l |

The metal ions in the table are only listed for example. One or more metal ions can be selected therefrom, depending on the metal(s) for electroplating and depositing. Using the concentration with the given range can ensure the electroplated metal-wire-layers uniformity and flatness.

When the trace of metal-wire layer 3 is formed in the surface of the insulating layer 2, the metal ions are relatively easily deposited on the trace of metal-wire layer 3 but not easily deposited at other positions of the insulating layer during the electrodeposition process, so that the metal-wire-layer 4 is formed to have a shape that is substantively consistent with the trace of metal-wire layer 3, as described above. A process of electrodeposition can be selected to manufacture the metal-wire-layer 4. The specific process of the electroplating is a common technique known in the art, and will not be described in details herein.

As can be seen from the method for manufacturing the magnetic passive component as illustrated above, the method according to the invention is easy to realize an automatic manufacturing, and is also beneficial to manufacture the magnetic passive component on a large scale. The manufacturing method is not only suitable to manufacture magnetic passive components with bar shape, but also suitable to manufacture magnetic passive components with a closed geometric shape. Since the trace of metal-wire layer is formed in the insulating layer surface, the method provided here for manufacturing the magnetic passive component with the closed geometric shape by laser activation is more convenient and easier than the traditional method for manufacturing the magnetic passive component with the closed geometric shape, and is easy to realize automatization. When manufacturing the magnetic passive component with large inductance, the processes of forming the trace of metal-wire layer and subsequently forming the metal-wire-layer also has advantage as compared with the traditional processes for manufacturing the magnetic passive component with large inductance or large number of coils. It is because the throughput of the electroplating process will not be affected by the number of coils of the magnetic passive component. According to the invention, the metal-wire-layer 4 is formed by the electroplating process to finally form one or more electrical loops around the magnetic core 1. When the specific trace of metal-wire layer 3 have been formed in the surface of the insulating layer 2 in the above steps, metal can be electroplated on the surface of the insulating layer 2 by electroplating technique.

In the present embodiment, the trace of metal-wire layer 3 is formed in the surface of the insulating layer 2 by laser activation. The metal-wire-layers 4 are preferably formed on the trace of metal-wire layer 3 by electroplating. The insulating layer 2 is formed by melting the insulating material containing metal ions at a high temperature or through other process into a molten state, and then casting and curing the melted material into a mold. The metal ions are doped into the insulating layer 2, the surface of which is treated by laser activation along a fixed routine. The location which is treated by the laser activation becomes rough to form the trace of metal-wire layer 3. Then, a line, that is the metal-wire-layer 4, is formed by electroplating on the trace of metal-wire layer 3. Moreover, after a product is completed, an insulating treatment can be performed on a whole outer surface of the magnetic passive component, so that the service life of the component can be extended or the voltage endurance can be improved. According to the invention, the magnetic core 1 can have a ring shape such as a circular shape (referring to FIG. 3B) or a long circular shape (referring to FIG. 2B), or alternatively have a “ [symbol] ”-character shape (referring to FIG. 4A-4B). The magnetic core having a “ [symbol] ”-character shape has a different depositing position of the trace of metal-wire layer 3 from that of the magnetic core having the ring shape. The trace of metal-wire layer 3 is deposited in a middle transversal portion of the “ [symbol] ”-character shaped structure. That is, four side fames of the “ [symbol] ”-character shaped structure do not have trace of metal-wire layer deposited thereon.

Although several preferred embodiments of the present invention have been described, the present invention may be used with other configurations. It will be appreciated by those skilled in the art that, the present invention could have many other embodiments, and changes and modifications may be made thereto without departing from the invention in its broader aspects and as set forth in the following claims and equivalents thereof

What is claimed is:

1. A magnetic passive component comprising:
a magnetic core;
an insulating layer coating the magnetic core; and
a metal-wire-layer deposited on a surface of the insulating layer, winding the surface of the insulating layer in a helical shape.

2. The magnetic passive component according to claim 1, wherein the metal-wire-layer comprises one or more electrical loops.

3. The magnetic passive component according to claim 1, wherein the magnetic core has a structure of a closed geometric shape.

4. The magnetic passive component according to claim 1, wherein the insulating layer is made from an insulating material containing additive of metal ions.

5. A method for manufacturing a magnetic passive component, said method comprising:
providing a magnetic core;
forming an insulating layer on the magnetic core, the insulating layer being made from an insulating material containing additive of metal ions;
forming a trace of metal-wire layer with a helical shape in the surface of the insulating layer; and
depositing a metal-wire-layer on the surface of the trace of metal-wire layer so as to finally form a metal winding wire on a surface of the magnetic core.

6. The method for manufacturing the magnetic passive component according to claim 5, wherein the trace of metal-wire layer is formed by laser activating the surface of the insulating layer.

7. The method for manufacturing the magnetic passive component according to claim 5, wherein the metal wire layer is formed by depositing the metal ions on the surface of the trace of metal-wire layer by an electroplating process.

8. The method for manufacturing the magnetic passive component according to claim 5, wherein the insulating layer is formed on the surface of the magnetic core by casting with a mold.

9. The method for manufacturing the magnetic passive component according to claim 5, wherein the magnetic core has a closed geometric shape.
